(19) United States
(12) Patent Application Publication
(10) Pub. No.: US 2017/0145176 A1
(43) Pub. Date: May 25, 2017

(54) METHOD FOR APPLICATION OF A SILICON DIOXIDE LAYER

(71) Applicant: EV Group E. Thallner GmbH, St. Florian am Inn (AT)

(72) Inventor: Jurgen Burggraf, Scharding (AT)

(73) Assignee: EV Group E. Thallner GmbH, St. Florian am Inn (AT)

(21) Appl. No.: 15/320,342

(22) PCT Filed: Jun. 26, 2014
(86) PCT No.: PCT/EP2014/063537

§ 371 Date: Dec. 20, 2016

(51) Int. Cl. C08J 7/04; B65D 65/42; D21H 25/04; D21H 19/20; D21H 27/10

(52) U.S. Cl. CPC C08J 7/04; D21H 19/20; D21H 27/10; D21H 25/04; B65D 65/42; C08J 2301/02

(57) ABSTRACT

A method for depositing a silicon dioxide layer on a combustible and/or, in particular easily, inflammable carrier material (2, 2′) for the formation of a package, in particular suitable for foodstuffs, with the following steps, in particular with the following sequence: coating of the carrier material with a silicon dioxide precursor solution prepared by dissolving an oligomeric, silicate, preferably a silicic acid tetramethyl ester homopolymer, in a solvent, said silicon dioxide precursor solution having a water content less than 5 vol. %, and hardening of the silicon dioxide precursor solution and thus forming the silicon dioxide layer on the carrier material in an at least partially vaporous ammonia atmosphere at: a temperature between 5° C. and 30° C. and/or a pressure between 900 MPa and 1200 MPa.

The invention relates to a method for depositing a silicon dioxide layer on a combustible and/or, in particular easily, inflammable carrier material for the formation of a package, in particular suitable for foodstuffs, according to claim 1.

The packaging industry is obligated and compelled by the legislator and customers to produce and continually improve packaging materials for the preservation, conservation and protection of goods, in particular foodstuffs.

The use of packaging as an isolating material has already been repeatedly revolutionised by the introduction of tin cans at the end of the 19th century of plastics and of aluminium-coated carboards. The tin can for first time permitted hermetic and therefore airtight sealing of foodstuffs. Plastics chiefly revolutionised the mass market by providing the possibility of the arbitrary formation of plastic packaging, as well as the high availability of plastics. Furthermore, metal, which is very expensive compared to plastics, could be dispensed with as a result of the use of plastics. So-called Tetra packs, aluminium-coated carboards, were finally used for the preservation of liquids in the middle of the 20th century.

Isolation generally serves to separate the packaged material to be protected, in particular foodstuffs, from the influences of the surroundings. The influences of the surroundings can be diverse. Many foodstuffs have to be packaged airtight, so that contact with atmospheric oxygen must be completely eliminated. In particular, these include foodstuffs that can be decomposed by aerobic bacteria. A further important aspect is isolation from biocontamination, i.e. protection against bacteria, fungi, lichens, viruses etc. Very many packages must also be resistant to humidity fluctuations, in order to keep the moisture content of the product to be protected constant.

Apart from the conventional, widely known packaging materials, composite packaging materials have existed for some years, which comprise at least one extremely thin, usually nanocrystalline or nanoamorphous, layer. The layers are chiefly made of inorganic, nonmetallic, partially crystalline materials. These materials are in the main ceramics, i.e. inorganic, non-metallic materials with a very low degree of crystallinity.

As a bulk material, ceramics have very characteristic properties. Compared to most metals, they are extremely brittle, very hard, usually have high strengths, are mainly non-conductors (except in the case of superconducting ceramics, the conductivity whereof only becomes evident however at very low temperatures). Furthermore, ceramics are extremely bio-inert and have a high level of availability.

The ceramic coating thus produced must however possess several properties that are decisive for its quality. In most cases, an impermeable ceramic layer is desirable. The impermeability prevents the diffusion of gases, the movement of viruses or bacteria from one side of the ceramic coating to the other. For many applications, the ceramic layer must be at least partially permeable, especially when oxygen transport from one side of the ceramic layer to the other side is to take place. In this case, a targeted adjustment of the pore size is desirable. Particularly preferably, the pore size is then set such that only a desired species, in particular gases, can pass through, whereas biological organisms are blocked.

One of the first problems with the use of faulty packaging already appeared in the 19th-century with the emergence of the tin can. At that time, tin cans contained toxic elements, which penetrated into the foodstuffs either through the wall of the tin can or through the solders with which the tin cans were sealed in those days. This case reveals the need to produce the packaging materials in such a way that they react as little as possible, preferably not at all, with the packaged goods, especially when it involves foodstuffs. The packaging material must not therefore be toxic. Packages are also very often composite materials, which comprise a number of different materials. In this case, the consideration naturally applies analogously to all the materials of the composite, in particular those coming into contact with foodstuffs.

Through the development of plastics at the beginning of the 20th century, a new class of material became available to the packaging industry, with the aid of which it became possible to package goods, again in particular foodstuffs, quickly, efficiently and above all cost-effectively. Plastics are characterised by excellent processing capabilities, extremely low prices, and arbitrary formability. The formability is usually dependent on the thickness of the packaging material used. Through the unique, molecular properties of plastics, the latter are able to the processed into wafer-thin films, the thicknesses whereof lie in the micrometer range. Dimensionally stable packages can be produced just as well from plastics.

Set against the positive properties of plastics are primarily their low environmental compatibility. Plastics are molecular, usually strongly interlinked, amorphous or (partially) crystalline substances, which in most cases have hydrophobic properties. They are not easily degraded by natural orgasms such as bacteria and decompose slowly. Very many plastics disperse and form might micro- and/or nanometre-size particles, which are absorbed by biological organisms. Moreover, many plastics contain undesirable chemical elements. Although the use of PVC has receded rapidly in recent decades on account of statutory regulations, negative effects are in part still discernible. Plastics are therefore generally to be regarded as not particularly environmentally compatible.

Tetra packs, which have been produced since the 50s in the 20th-century, have also enjoyed an unprecedented success. A Tetra pack is a cardboard coated at least on the inside. The coating usually comprises a wafer-thin aluminium foil. The outer sides are usually also coated with a plastic film, in particular polyurethane. An intermediate layer of plastic is also conceivable between the cardboard and the aluminium. The different layers are joined by a connecting layer. This composite material can be produced efficiently and cost-effectively in the form of a line process, then cut out, folded and fixed in its final shape and connected. Since Tetra packs, in contrast with plastics, represent a composite material, the individual types of material have to be produced separately from one another by time-consuming and costly processes. The recycling is correspondingly complicated, time-consuming and costly.

The aforementioned packaging methods have decisive drawbacks, in particular environmental pollution. Plastics and Tetra packs in particular are very poorly degradable.

The problem of the present invention, therefore, is to provide a method with which a package, in particular suitable for foodstuffs, can be produced, which is as bio-inert as possible. A further problem consists in providing a favourable production method with an energy expenditure as low as possible.

This problem is solved with the features of claim 1. Advantageous developments of the invention are given in the sub-claims. All combinations of at least two features given in the description, in the claims and/or the figures also fall within the scope of the invention. In stated value ranges, values lying inside the stated limits are also deemed to be disclosed as limiting values and can be claimed in any combination.

The basic idea of the present invention is to deposit silicon dioxide at low temperatures between 5° C. and 100° C., in particular without heating, preferably at a room temperature and/or in the region of atmospheric pressure, in particular without separate application of pressure, on a carrier material or carrier substrate or to impregnate a voluminous carrier material therewith. A preferred temperature range lies between 5 and 50° C., more preferably between 5 and 30° C.

In other words, the invention relates in particular to a method for producing a nanocrystalline ceramic coating constituted in particular as a barrier layer, in particular a silicon dioxide coating, at comparatively low temperatures, in particular at room temperature. The silicon dioxide coating is preferably used for coating packaging material, in particular for the formation of a package.

Furthermore, the invention describes a packaging material produced with the aid of the method according to the invention, preferably usable for the foodstuffs industry.

According to the invention, packaging materials are understood to mean in particular objects for the protection of a (foodstuff) object against its environment. Packaging materials according to the invention are in particular (plastic) films or (paper) cardboards.

In particular, the invention deals with a method for coating a carrier material, in particular a plastic, more preferably a cellulose-containing material, at low temperatures, preferably at room temperature, with a ceramic layer, preferably silicon dioxide, constituted in particular as a barrier layer. The carrier material is preferably a packaging material, in particular cardboard, paper or plastic. Particularly preferably, packaging materials for foodstuffs are coated with the embodiment according to the invention.

In a special embodiment according to the invention, the surface of a rigid and stiff, in particular large-volume object, for example a wafer box, can also be coated.

In a further, in particular independent, embodiment according to the invention, the impregnation of carrier materials or carrier substrates made of wood, wool, in particular cotton, or all kinds of clothing items produced therefrom is conceivable. In particular, a coating of the inner surface of the large-volume, in particular porous or permeable carrier material takes place in the impregnation process. The inner surface is a surface of hollow spaces, i.e. in particular excluding surfaces of the carrier material lying on the outside.

The layer thickness of the ceramic layer/silicon oxide layer on the first surface and/or second surface and/or the inner surface of the carrier material/carrier substrate is in particular less than 1 μm, preferably less than 100 nm, still more preferably less than 10 nm, most preferably less than 1 nm.

An explanation concerning the fracture behaviour of bulk ceramics preferred according to the invention, in particular with a ceramic layer according to the invention, is given below.

Bulk materials are subjected to tensile loading (more seldom to compressive loading) and very often to bending and torsion, in order that material-specific magnitudes such as the tensile strength, yield strength or the fracture stress can be ascertained. In the main, ceramics are extremely brittle and are therefore ranked among the brittle materials. A characteristic feature of brittle materials (such as ceramics) is a very small (in the ideal case of brittle materials, infinitesimally small or completely non-existent) plastic deformation. Brittle components thus fracture spontaneously when the fracture stress is exceeded, without becoming plastically deformed beforehand. The ascertainment of the fracture stress usually takes place by tensile loading. The component fractures in the presence of a mono-axial tensile load when the tensile stress is greater than the fracture stress. With a general, multi-axial stress state, a comparative stress is calculated which is compared with the fracture stress of the component.

The ceramic layer according to the invention, in particular deposited thin, should serve in the application primarily as an isolating material on a carrier layer. Correspondingly, the thin ceramic layers are mainly subjected to bending load.

As a result of the extremely small thickness of the ceramic layer (preferably in the nanometre range), the packages thus produced can be bent almost arbitrarily without fracture of the applied ceramic layer occurring. The bending stresses, induced in the ceramic layer in particular by bending of the packaging material, are so small on account of the small layer thicknesses that they (or their calculated comparative stress) do not exceed the fracture strength of the material. Packages produced according to the invention can thus be deformed without running the risk of destroying the ceramic layer by deformation.

The method according to the invention permits the coating of virtually any carrier materials at low temperatures, in particular at room temperature. Ceramics, in particular silicon dioxide, can also be deposited on the carrier material by the process according to the invention. A completely new possibility is thus opened up for the packaging industry.

According to the invention, the silicon dioxide layer is constituted in particular as a barrier layer. According to the invention, provision is in particular made such that a package comprising at least an inner film can, as a result of the provision of a barrier layer, acquire an improved passage blocking effect against at least one chemical compound and/or at least one chemical element, in particular water vapour and/or gases and/or another chemical compound, e.g. essential oils or solvents and/or a chemical element, in order to protect a product lying inside, in particular a foodstuffs product, for example a coffee powder, against ageing phenomena, in particular oxidation phenomena or other impairments. Furthermore, the applicant has recognised that is advantageous for the protection of the barrier layer against external mechanical influences to arrange this barrier layer in the interior of the container body, as a result of which a top lacquering with a protective lacquer layer in principle can (but does not have to) be dispensed with.

The ceramic coating is preferably a functional coating, which protects against the passage of moisture and/or gases. The coating is preferably selected such that it reduces migration phenomena from the packaged product into the at least one plastic layer. Very particularly preferably, the barrier layer is additionally or alternatively designed in such a way that, by means of the latter, the entry of chemical substances and/or elements from the at least one plastic layer into the packaged product is minimised. Such properties are, in particular, extremely advantageous in the case of the formation of the packaging or a packaging container produced from the packaging as a foodstuffs packaging container. Particularly in the case of the packaging of spices, it is advantageous if the barrier layer has a passage blocking effect against essential oils. Especially when technical products are to be packaged in the packaging container, it is preferable if the barrier layer has a passage blocking effect against solvents.

The plastic layer for the production of the packaging or the packaging container produced therefrom is in particular used as a carrier substrate or carrier material. The latter is preferably produced by injection moulding, injection blow moulding, blow moulding and/or deep drawing. In particular, polyethylene (PE), polypropylene (PP), cycloolefine copolymers (COC), cycloolefine polymers (COP), polyvinyl chloride (PVC), polyethylene terephthalate (PET), polyimide (PA) or polystyrene (PS) are suitable as materials. It is also possible to use packaging moulded parts made of compostable polymers, in particular polymers based on renewable raw materials, such as starch-based polymers (starch blends, PLA (polyazide), polyester of the type PAH (polyhydroxy alconoate), e.g. PHB (polyhydroxy butyrate), PHV (polyhydroxy valerate), cellulose materials, materials produced from chemically modified cellulose. Polymers based on renewable raw materials are in particular specific polymers, e.g. based on PDO (biopropane diol), specific polyamides, e.g. produced from castor oil, as well as polyethylene (PE), polypropylene (PP), polyvinyl chloride (PVC), based on bio-ethanol, as well as specific synthetic polyesters produced from crude oil or natural gas, or laminates produced from the stated materials.

An aspect according to the invention consists in particular in the application of a low-temperature coating process for coating combustible and/or easily inflammable materials, in particular of plastics and/or cellulose-containing materials.

The different types of material form a packaging framework or packaging bulk material, referred to subsequently as carrier substrate or carrier material, for the production of a package. The carrier substrate can be a large-volume component formed in an arbitrarily complicated manner, for example a plastic bottle. The following would be conceivable:
films
cardboards
bottles
fibres, in particular
   natural fibres
   plant fibres
   aminal fibres
boxes, in particular
   wafer boxes
clothing
furniture
   Use in packages, in particular foodstuffs packages, is preferred.

The embodiment according to the invention is particularly well suited for the coating of the following material classes
metals
ceramics
plastics
composite materials, in particular
   carbon fibre composite materials
natural materials, in particular
   wood
   animal skin (or leather arising therefrom)
   fibre-containing natural materials, in particular
      wool, in particular
         cotton
   cellulose-containing natural materials
   lignin-containing natural materials

In a preferred embodiment, the carrier substrate has a plate-shaped and/or film-like structure. In particular, plastic films or cellulose-containing papers or cardboards are coated using the method according to the invention, the latter being further processed in further process steps and/or shaped. According to the invention, the coating of a flat cardboard which is reshaped in further process steps to form a rectangular packaging carton would, amongst other things, be conceivable.

According to the invention, a carrier material or carrier substrate is in particular selected which has
a) a flash point >0° C. and <100° C. and/or
b) a combustion point >20° C. and <150° C. and/or
c) an ignition temperature >100° C. and <600°C., preferably >150° C. and <300° C.

The ceramic layers according to the invention can be optimised especially with regard to permeability or impermeability of gases.

If the ceramic layers according to the invention are to be optimised for the permeability of gases, the ceramic layer is in particular deposited in such a way that it has an open porosity. The porosity is defined by the degree of porosity. According to the invention, this is defined as the ratio between the pore volume and the total volume. If there are no pores in the material, the degree of porosity is correspondingly zero. The degree of porosity for permeable ceramic layers according to the invention is in particular greater than 0.0001%, preferably greater than 0.01%, more preferably greater than 1%, most preferably greater than 5%, with utmost preference greater than 10%, most preferably of all greater than 25%. In particular, it can thus be established how many molecules can pass through the ceramic layer per unit of time.

For permeable ceramic layers, an average pore diameter or an average pore size is selected by the process according to the invention in particular at least as large as the average diameter of the type of molecule that is intended to pass through the ceramic layer. For permeable ceramic layers, the average pore diameter is therefore preferably greater than 1 nm, preferably greater than 10 nm, more preferably greater than 50 nm, with utmost preference greater than 100 nm.

The average pore diameter is understood to mean the average diameter of the pores. The pores are preferably assumed to be radially symmetrical. For an accumulation of a plurality of pores along a section, and the formation of a pore tube, this would correspondingly be the average tube diameter. The average pore diameter in particular represents an upper limiting value for the molecular size of the molecules that are intended to penetrate via the pores into the ceramic layer.

If the ceramic layers according to the invention are intended to be optimised for the impermeability of gases, the ceramic layer is in particular deposited in such a way that it has a closed porosity, more preferably no porosity. The degree of porosity is in particular less than 25%, preferably less than 10%, more preferably less than 5%, still more preferably less than 1%, most preferably less than 0.01%, with utmost preference less than 0.0001%.

For impermeable ceramic layers, the average pore diameter is in particular less than 100 nm, preferably less than 50 nm, more preferably less than 10 nm, with utmost preference less than 1 nm.

In a first embodiment according to the invention, the low-temperature coating process is used to coat a first side of a first carrier substrate with a ceramic layer according to the invention, in particular a silicon dioxide layer. The layer thickness of the ceramic layer is in particular less than 1 μm, preferably less than 100 nm, still more preferably less than 10 nm, most preferably less than 1 nm and preferably has one of the aforementioned porosity properties.

In a second embodiment according to the invention, the low-temperature coating process is used to coat both sides of a first carrier substrate with a ceramic layer according to the invention, in particular a silicon dioxide layer. The thickness of the first ceramic layer on the first side of the carrier substrate is in particular less than 1 μm, preferably less than 100 nm, still more preferably less than 10 nm, most preferably less than 1 nm and, particularly in relation to both ceramic layers in common, preferably has one of the aforementioned porosity properties. In particular, the thickness of the second ceramic layer on the second side of the carrier substrate is equal to the thickness of the first ceramic layer on the first side of the carrier substrate. The thicknesses of the two ceramic layers can however also be different, in order to be able to take account of different requirements on the two sides.

In a third embodiment according to the invention, the low-temperature coating process is used to coat the inner surfaces of a porous carrier substrate with a ceramic layer according to the invention, in particular a silicon dioxide layer. The thickness of the ceramic layer on the inner surface of the carrier substrate is in particular less than 1 μm, preferably less than 100 nm, still more preferably less than 10 nm, most preferably less than 1 nm. Following the coating of the inner surface of the carrier substrate, a coating of the first and/or second surface of the carrier substrate can in turn take place according to the first two embodiments according to the invention.

The embodiments according to the invention are produced by a low-temperature coating process, which prevents combustion or oxidation or thermal decomposition or pyrolysis of the carrier material. A particularly preferred process is a low-temperature coating process wherein a silicon oxide layer is deposited in an ammonia atmosphere.

In a first process step, a silicon precursor (silicon precursor, i.e. a molecule containing silicon) with a water content of less than 50 vol. %, preferably less than 25 vol. %, still more preferably less than 10 vol. %, most preferably less than 5 vol. %, is prepared by mixing a silicate, in particular an oligomeric organosilicate, more preferably a silicic acid tetramethyl ester homopolymer, with a solvent. The oligomeric organosilicate typically and, in particular, predominantly comprises silicic acid tetramethyl ester monomers. It can be supplemented by any other monomers. The solvent is in particular an alcohol, water or an alcohol-water mixture. The silicon precursor preferably has a quantitative ratio of 0.01-1 parts water to 0.02-100 parts alcohol, related to 1 part of the underlying polymer. The pH value of the precursor lies between 0 and 14, preferably between 3 and 11, still more preferably between 5 and 9, most preferably around 7.

In a second process step, this silicon precursor is deposited on the surface to be coated and hardened in an ammonia-containing atmosphere. The deposition takes place by one of the following process:
spin coating (spin process)
spray coating
chemical vapour deposition (CVD)
plasma-enhanced chemical vapour deposition (PE-CVD)
physical vapour deposition (PVD)
dip coating
electrochemical coating
electroless deposition
organometallic decomposition
sol-gel processes

The deposited precursor layer is then subjected to ammonia in an ammonia atmosphere. The ammonia atmosphere, in particular, comprises predominantly water, ammonia and alcohol. The atmosphere for the hardening according to the invention is in particular produced from a liquid mixture of alcohol and ammonia solution. The volume ratio of alcohol to ammonia solution lies between 0.01 and 100, preferably between 0.1 and 10, most preferably at 1. The same quantities of alcohol and ammonia are therefore preferably used. For example, in the case of 10 ml of alcohol, 10 ml of ammonia solution is preferably used in order to produce the atmosphere. The concentration of the ammonia solution lies in particular between 5% and 50%, preferably between 10% and 40%, most preferably between 20% and 30%, most preferably of all at 25%. The produced liquid mixture evaporates and thus provides the ammonia atmosphere hardening the silicon precursor.

In a preferred embodiment according to the invention, the introduction of ammonia gas into the working chamber takes place. The ammonia gas is preferably mixed with an alcohol, in particular methanol.

Furthermore, an addition of a carrier gas in particular takes place, in particular of nitrogen, for the transport of the alcohol and/or the ammonia. Ammonia solutions as a liquid can be completely dispensed with by the introduction of an ammonia gas. In both embodiments according to the invention, the pressure during the hardening of the silicon precursor in the working chamber is between 10⁻³ mbar and 10 bar, preferably between 10⁻¹ mbar and 5 bar, still more preferably between 0.8 bar and 1.2 bar, most preferably at 1 bar.

An essential advantage accorded to the invention consists in the fact that the production of ceramic layers, in particular silicon dioxide layers, is possible at room temperature or at least at very low temperatures, in particular temperatures below the flash point and/or combustion point and/or decomposition point of the carrier material. It is only in this way that the inventive coating of a plastic and/or a cellulose-containing material is enabled.

In order to ensure a high product throughput in the production of a package according to the invention, it has proved to be advantageous to allow the container bodies to run in a geometrically linear manner (preferably a translatory manner) through coating means for the deposition of the ceramic coating, i.e. to constitute the transport path in such a way that the container bodies run only once through a given position of the coating means. Continuous production is thus enabled, a high throughput being enabled by the fact that container bodies can be supplied to and removed from the coating means simultaneously.

Further advantages, features and details of the invention emerge from the following description of preferred examples of embodiment and on the basis of the drawings. In the figures:

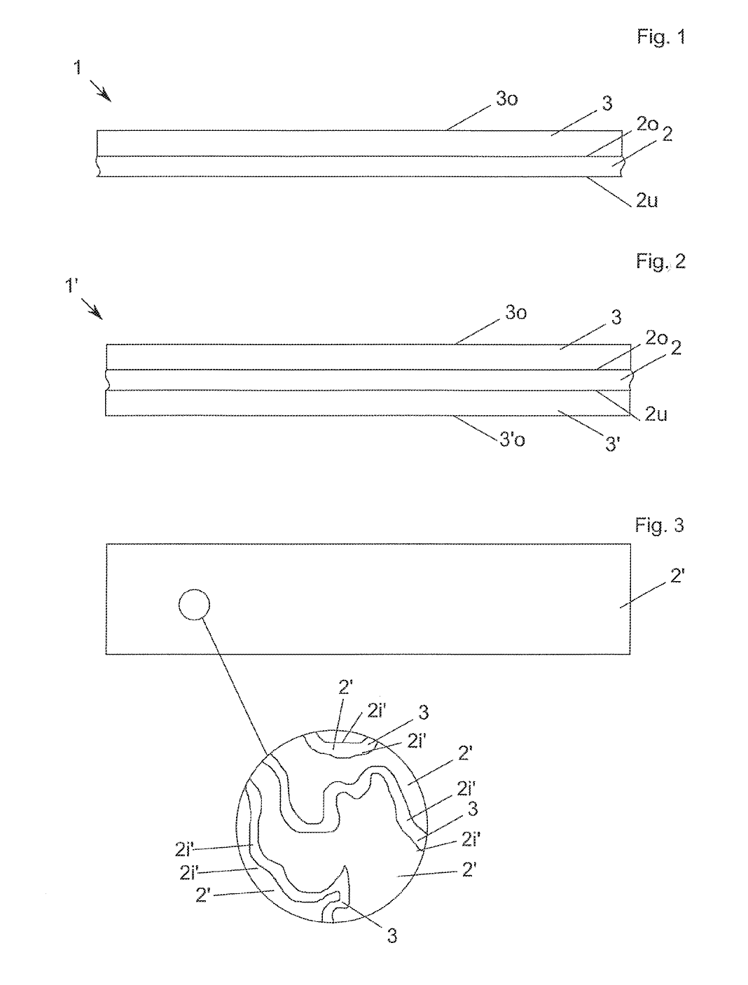

FIG. 1 shows a schematic cross-sectional partial representation (not true to scale) of a first embodiment according to the invention,

FIG. 2 shows a schematic cross-sectional partial representation (not true to scale) of a second embodiment according to the invention,

FIG. 3 shows a schematic cross-sectional partial representation (not true to scale) of a third embodiment according to the invention.

Identical or identically functioning features are denoted in the figures by the same reference numbers.

FIG. 1 shows a schematic cross-sectional partial representation (not true to scale) of a package 1, represented only as a detail, with a carrier substrate 2, in particular a plastic film or a. cellulose-containing material, which on its first surface 2o has been coated at atmospheric pressure and room temperature with a ceramic layer, i.e. a silicon dioxide layer 3.

FIG. 2 shows a schematic cross-sectional partial representation (not true to scale) of a package 1′, represented only as a detail, comprising:
a carrier substrate 2, in particular a plastic film or a cellulose-containing material, with first surface 2o and a second, opposite-lying (lower) surface 2u,
a ceramic layer 3 deposited on first surface 2o and
a ceramic layer 3′ deposited on second surface 2u.

FIG. 3 shows a schematic cross-sectional partial representation (not true to scale) of a voluminous carrier substrate 2′, inner surfaces 2i′ whereof have been coated with a ceramic layer 3 by the method according to the invention. The coating of inner sides 2i′ of a voluminous carrier substrate 2′ can also be understood to mean impregnation.

### LIST OF REFERENCE NUMBERS

1, 1′ packaging/packaging film
2, 2′ carrier substrate/carrier material
2o first surface
2u second surface
2i′ inner surface
3, 3′ silicon dioxide layer
3o, 3o′ third surface

1-6. (canceled)

7. A method for producing a package material for foodstuffs by depositing a silicon dioxide layer on a cellulosecontaining carrier material and/or for impregnation of a voluminous carrier material with a silicon dioxide layer, wherein the carrier material is comprised of a material having a) a flash point greater than 0° C. and less than 100° C. and/or b) a combustion point greater than 20° C. and less than 150° C. and/or c) an ignition temperature greater than 100° C. and less than 600° C., wherein the method comprises:
coating the carrier material with a silicon dioxide precursor solution prepared by dissolving a silicate in a solvent, said silicon dioxide precursor solution having a water content less than 25 vol. %, and
hardening the silicon dioxide precursor solution to form the silicon dioxide layer on the carrier material in an at least partially vaporous ammonia atmosphere, wherein the at least partially vaporous ammonia atmosphere is at a) a temperature between 5° C. and 100° C. and b) a pressure between 10⁻³ mbar and 10 bar.

8. The method according to claim 7, wherein the silicate is a silicic acid tetramethyl ester homopolymer.

9. The method according to claim 7, wherein the silicon dioxide layer is deposited/formed with a layer thickness less than 1 μm.

10. The method according to claim 7, wherein the coating and/or the hardening is/are carried out at room temperature and/or atmospheric pressure.

11. The method according to claim 7, wherein the carrier material is made of a material with an ignition temperature greater than 150° C. and less than 300° C.

12. The method according to claim 7, wherein the carrier material, before deposition of the silicon dioxide layer, is treated with a plasma on at least one surface to be coated.

13. A wafer box, produced with a carrier material coated with a method according to the method of claim 7.
